(19) United States
(12) Patent Application Publication
(10) Pub. No.: US 2005/0036741 A1
(43) Pub. Date: Feb. 17, 2005

(54) Method and apparatus for correcting attachment induced positional shift in a photonic package

(76) Inventors: Mark Rodighiero, Arcadia, CA (US); Geoff Shannon, Arcadia, CA (US)

Correspondence Address: CHRISTIE, PARKER & HALE, LLP, PO BOX 7068, PASADENA, CA, 91109-7068, US

(21) Appl. No.: 10/802,666

(22) Filed: Mar. 17, 2004

Related U.S. Application Data
(60) Provisional application No. 60/455,644, filed on Mar. 17, 2003.

(51) Int. Cl. G02B 6/26

(52) U.S. Cl. 385/52; 385/90

(57) ABSTRACT

A method of aligning optical components of a photonic package is provided. First, the optical components are aligned initially. Then the optical components are fixed with respect to one another through laser welding. A direction to deform one of the optical components is determined through applying a sweep of constant force vectors on the photonic package using a gripper. A force is applied in the selected direction to plastically deform one of the optical components to re-align the optical components. A force feedback signal may be provided to be used for controlling the applied force vector.

### CROSS-REFERENCE TO RELATED APPLICATION(S)

This application claims priority to and the benefit of U.S. Provisional Patent Application No. 60/455,644 entitled “Method and Apparatus for Correcting Attachment Induced Positional Shift in a Photonic Package” filed Mar. 17, 2003, the entire content of which is incorporated by reference herein.

### BACKGROUND

Photonic packages typically require precise alignment of various different optical and/or electro-optical components in order to obtain desired performance. Once aligned, these components should be permanently fixed with respect to one another to maintain their coupling efficiency. It is often difficult to achieve such precise alignment because photonic devices typically require positional tolerances in the sub-micron range. The permanent fixation may be achieved using various different methods including soldering and adhesive bonding, however, laser welding is often used because it typically results in higher production rates and provides an easier route to automation.

Pulsed Nd:YAG lasers are used for such laser-welding. However, even with laser welding, misalignment often occurs during the fixing process. By way of example, when a fiber carrying ferrule is aligned with an optical source, misalignment may occur when the welded materials cool and solidify due to what is commonly referred to as post-weld shift. Post weld shift occurs as the weld between the ferrule and clip pulls down the ferrule as it cools. Other misalignments may also be caused dimensional changes through cooling, material phase changes, material shrinkage, and the like.

Various methods for post-attachment corrections have been developed for precise alignment of the optical components. Some of these methods are directed to mechanically adjusting the relative position or shape of the parts after welding. In particular, mechanical shape adjustment (e.g., bending) of parts have been considered for providing the requirement alignment. However, achieving precise sub-micron alignment of optical components through mechanical adjustment of parts is not straightforward.

When a force is applied to the parts, there are at least two resultant effects; how far the part moves and in what direction. These two effects generally relate to the parts level of constraint in the direction of bending, and more specifically to the interaction of localized constraint effects at the fixing points of the parts, the mechanical stiffness of the parts and the stiffness of part mounts and stages. For example when a force is applied to a ferrule and clip assembly, the resultant direction of bending may not perfectly match the applied bending force direction. The bending response, distance and angle, is generally hinted at by the applied force angle and magnitude of the applied force but is ultimately determined by the fixing points, stiffness vectors of the ferrule/clip assembly and the stage set in the original applied plane of bending. The resultant bending of the assembly is a dynamic effect, in that, during the bending procedure the actual bending path may continually change, however, as long as the yield point of the assembly is not reached the degree of bending is directly proportional to the amount of the applied force. Considering a position based bending system even at this non-permanent level of bending has a flawed method, as the stage set and tooling will have a degree of play such that repeated motion will produce a non-repeatable varying defection of the parts.

In order to permanently re-align the parts, a force must be applied that induces the clip to yield, and undergo plastic deformation. In order to bend parts a controlled amount, or to make parts stay bent a controlled amount, good control must be exercised over the magnitude and direction of the applied bending force. The magnitude and direction of the applied bending force, for example, may be referred to as a force vector.

One proposed solution to accomplish post weld shift bend alignment is to command motion stages to move a certain distance (e.g., change in position) from a starting point. If a co-ordinate based bending systems that induces bending by positional references is used then the method of bending is not deterministic or repeatable. When plastic deformation occurs, the linear relationship between stage position and the relative bend position of the parts ceases to exist. Each subsequent attempt to bend the part, specifically the magnitude of bending will correspond to a constantly changing co-ordinate position, that is part a function of the assembly bending, the stage set bending that is not reported back by encoder counts and bending in the tooling. As the variation in the actual force vector that is communicated to the part varies, there may be great inconsistencies in the effects of existing bending alignment methods.

Therefore, it is desirable to provide an apparatus and method for providing a good control over the applied force vector for precisely aligning the optical components after permanent fixation (e.g., through laser welding).

### SUMMARY OF THE INVENTION

In an exemplary embodiment according to the present invention, a method of aligning optical components of a photonic package is provided. The method comprises: initially aligning the optical components; fixing the optical components with respect to one another through laser welding; determining a direction to deform one of said optical components through performing a sweep of force vectors; and applying a force to plastically deform said one of the optical components to re-align the optical components.

In another exemplary embodiment according to the present invention, a system for performing force bending to re-align optical components of a photonic package after permanent fixation is provided. The system comprises: a stage capable of providing movements and exerting force in at least one direction; and a gripper suitable for grabbing an optical component of the photonic package, wherein the gripper performs a sweep of force vectors on at least one of the optical components of the photonic package in an automated manner to determine a direction to deform a supporting member coupled to said at least one of the optical components to re-align the optical components.

### BRIEF DESCRIPTION OF THE DRAWINGS

These and other aspects of the invention may be understood by reference to the following detailed description, taken in conjunction with the accompanying drawings, wherein:

FIG. 1 is a top view of a photonic package, to which an exemplary embodiment of the present invention can be applied;

FIG. 2 is an enlarged view of an interface between a fiber and a laser chip;

FIG. 3 is a top view that shows welds between a ferrule and a clip, and between the clip and a base;

FIG. 4 illustrates welding of a clip to a base;

FIG. 5 illustrates a control feedback loop used for post welding re-alignment;

FIG. 6 is a flow diagram illustrating a process of aligning optical/opto-electronic components of a photonic package in an exemplary embodiment according to the present invention;

FIG. 7 is a perspective view of a gripper (“grippers”) being used for alignment of optical components in an exemplary embodiment according to the present invention;

FIG. 8 is a flow diagram illustrating a process of force bend alignment in an exemplary embodiment according to the present invention;

FIG. 9 is a flow diagram illustrating an iterative process of force bend alignment using a linear force mode in another exemplary embodiment according to the present invention; and

FIG. 10 is a flow diagram illustrating an iterative process of force bend alignment using a constant force mode in yet another exemplary embodiment according to the present invention.

### DETAILED DESCRIPTION OF THE INVENTION

In an exemplary embodiment according to the present invention, an optical coupling signal is used as feedback to determine the effectiveness of the force vector in correcting for post weld shift caused by laser welding, i.e., the amount of bending. The process of bending one or more parts for post weld shift correction may be referred to as “bend alignment” or “force bend alignment.” In order to achieve control over the applied force vector during force bend alignment, a control feedback loop is used to measure the actual force applied to the parts. Hence, an excellent control over the applied force vector can be provided, because a user (using a machine of the bend alignment system) directly controls and monitors the actual resultant force vector that the motion stages apply to the parts. Therefore, the applied force vector can be accurately communicated to the parts through the motion stages and tooling, in spite of imperfections (e.g., sloppy bearings) that may exist in the motion stages, toolings and/or other mechanisms.

A method and apparatus in the exemplary embodiment include the following steps: 1) determining the direction of necessary corrective motion; and 2) applying a force vector (which may be predetermined) of sufficient magnitude to one or more of the optical or electro-optical components in question so that the mounting components are plastically deformed to the correct orientation. The magnitude, direction, rate of force application, and duration of force application (collectively called the “force profile”) can be adjusted either manually by the machine operator and/or automatically via automatic control. The term “optical components” may be used broadly herein to refer to the optical components and/or the opto-electronic components.

Therefore, in the described embodiment, instead of automatically moving one part relative to the other a specified distance, a specific force is applied to the structure. This way, the method of determining the extent and direction of the required change in relative position is unaffected by lost motion of the gripper or supporting structure. For example, the applied force is transmitted through the structure in a highly predictable manner. Further, the final correction of relative positions may be achieved by plastically deforming the component structure, using the same force transmission path as was used in the initial extent and direction determination step.

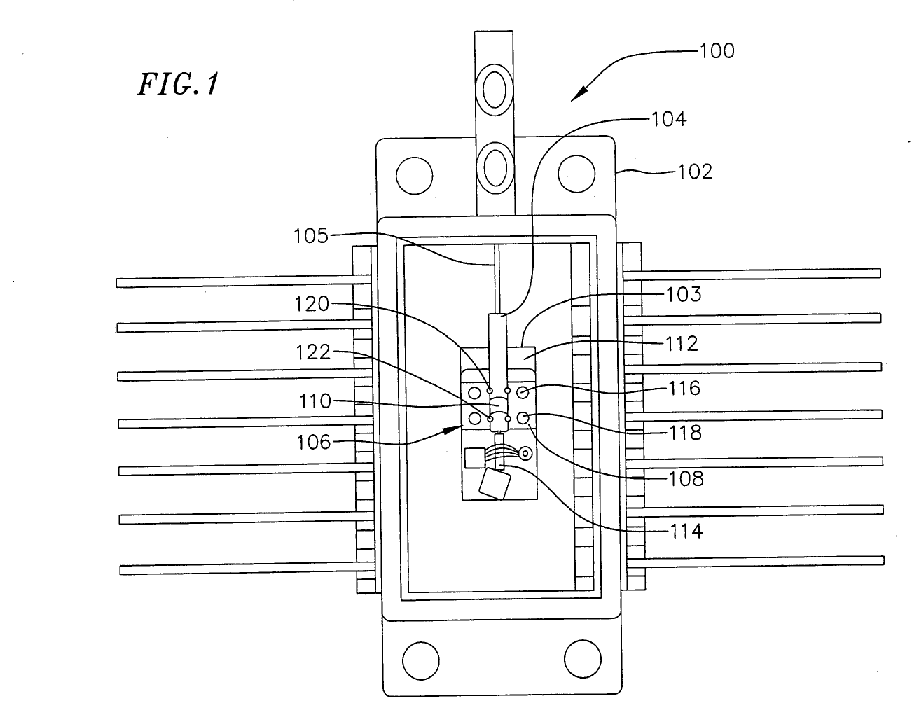

FIG. 1 is a top view of a photonic package 100, to which an exemplary embodiment according to the present invention can be applied. The photonic package 100 includes a package 102, a welding base 103, a ferrule 104, a clip 106 and a laser 114 (e.g., a laser chip/laser diode). The photonic package 100 may also include other components including, but not limited to, a thermoelectric cooler and a base for the laser 114.

The package 102 is a butterfly or miniDIL (mini dual in-line) package in the exemplary embodiment. In other embodiments, any other suitable package commonly used by those skilled in the art for manufacturing photonic packages may be used instead of the butterfly or miniDIL package. The base 103 is fixedly mounted inside the package 102, the clip 106 is laser welded to the base 103, and the ferrule 104 is laser welded to the clip 106. The ferrule 104 encases at least a portion of an optical fiber 105.

The clip 106 is made up of rectangular flange members 108 for attaching the clip to the base 103 and a semi-circular connecting (bridge) member 110 that connects (bridges) the flange members 108. The connecting member 110 should be sized such that it loosely holds the ferrule 104 so that the ferrule can be moved with ease with respect to the clip prior to welding the two. The base 103 may be made from gold plated Kovar®, molybdenum or any other suitable material. Kovar® is a registered trademark of CRS Holdings, Inc., Wilmington, Del.

The clip 106 should be made of thin and annealed weldable material suitable for bending without breaking. Further, the clip 106 should not change in size over time and temperature. For example, the clip 106 may be made from stainless steel (e.g., 304L alloy), nickel, Kovar® or any other suitable metal. The clip 106 may be fabricated through electric discharge machining and/or stamping. Since the clip supports fixation of the ferrule 104, the clip may also be referred to as a supporting member.

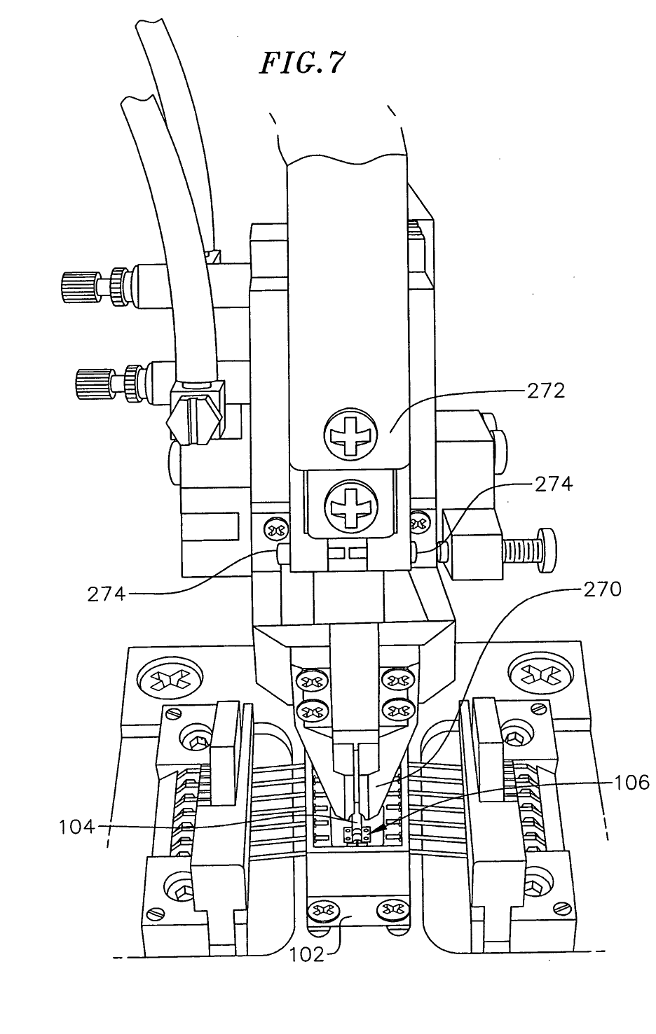

During the fabrication of a typical photonic package, the package 102 is loaded onto a mount. The ferrule 104 may be pre-placed into the package 102 or it may be placed into the package after loading the package 102 onto the mount. In either scenario, the ferrule 104 prior to permanent fixation (e.g., through laser welding) may be fixed, for example, with a clamp (not shown) to the base 103. The mount is then placed onto a stage stack that contains a y stage as well as θx (theta x), θy and θz stages. A gripper (or grippers, shown on FIG. 7, for example) may then be positioned in place to grab the ferrule 104. The gripper may also be moved independently of the stage stack, for example, in x and z directions. In other embodiments, the stage stack may have different number and/or combination of stages, and the gripper may have other movements in addition to or instead of moving in x and z directions.

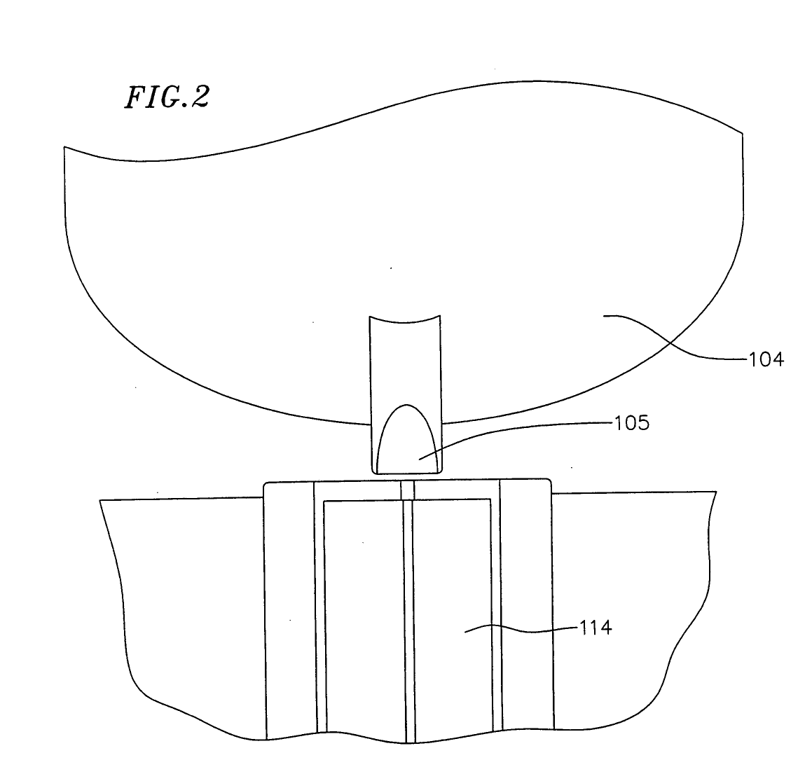

The ferrule 104 is then edged toward the laser chip 114 using the gripper to be aligned. Once the fiber 105 is initially aligned with the laser chip 114, the clip 106 is slipped over the ferrule 104 and welded to the base 103 with welds 116 and 118. FIG. 2 is an enlarged view of an interface between the fiber 105 encased in the ferrule 104 and the laser chip 114 in an exemplary embodiment according to the present invention.

Returning now to FIG. 1, in other embodiments, the clip 106 may be placed over the ferrule 104 either before or after the alignment between the fiber 105 and the laser chip 114. After the clip 106 is welded to the base 103 on a surface 112 with welds 116 and 118, the clip 106 is welded to the ferrule with welds 120 and 122. The gripper then releases the ferrule 104. Due to one or more of misalignment inducing phenomena, the strength of the optical signal is typically insufficient at this point. Therefore, force bend alignment of mechanically plastically deforming the clip 106 should be performed in the exemplary embodiment. In other embodiments, the laser chip 114 may be replaced, for example, by a photodetector to fabricate an optical receiver.

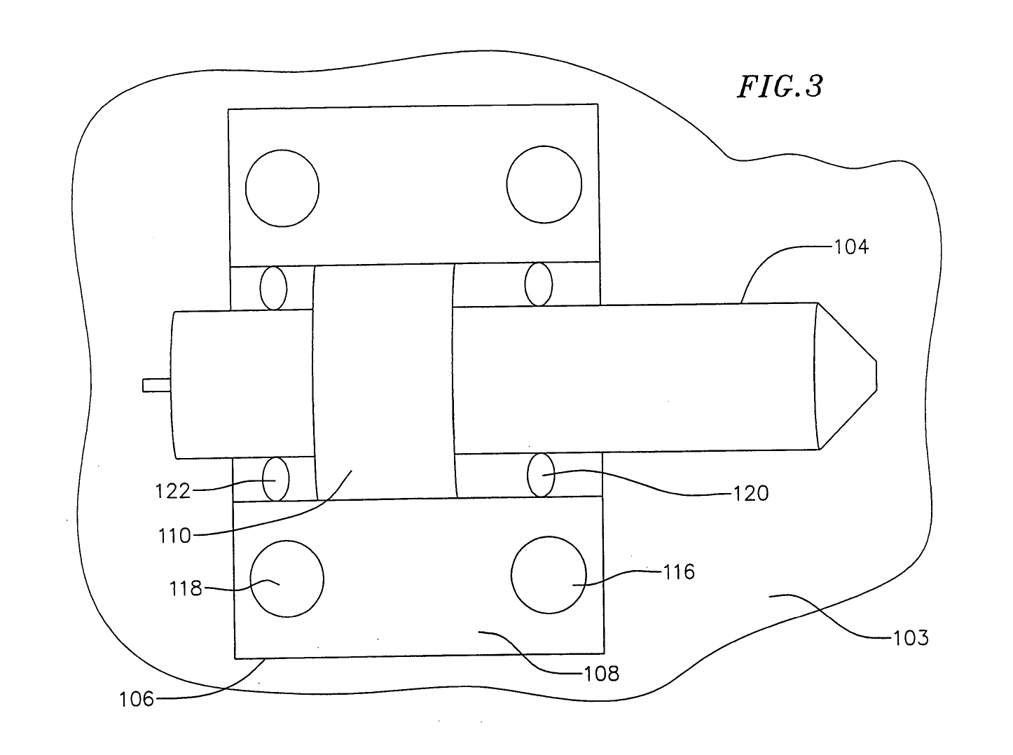

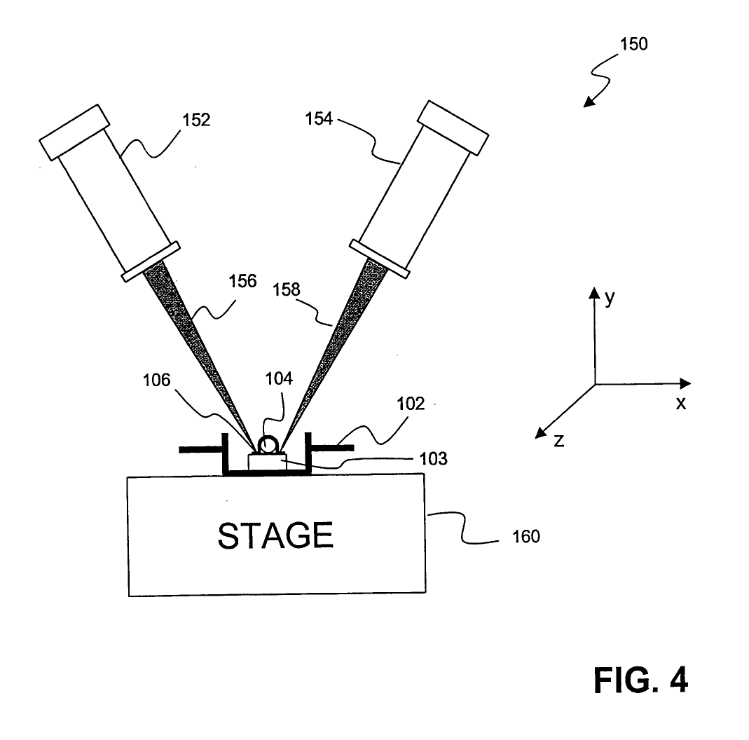

FIG. 3 is a top view illustrating welds between the ferrule 104 and the clip 106, and between the clip 106 and the base 103. The welds 116 and 118 are used to weld the clip 106 to the base 103, while the welds 120 and 122 are used to weld the ferrule 104 to the clip 106. The welds 116, 118, 120 and 122, for example, may be performed using a weld setup such as a weld setup 150 of FIG. 4.

In FIG. 4, the package 102 on a mount (not shown) is placed on a stage 160. For example, the stage 160 may include a stage stack containing a y stage for adjustment in they direction, and θx (theta x), θy and θz stages for adjustments in θx, θy and θz, respectively. In other embodiments, the stage stack may include a different number and/or combination of stages.

The weld setup 150 illustrates that pulsed lasers 152 and 154 direct their beams 156 and 158 to weld the clip 106 to the base 103. The laser beams 156 and 158 should deliver balanced energies that are substantially equal in strength to each other. By way of example, the energies delivered by the laser beams 156 and 158 may be within 3% of each other. The balancing of the welding beam energies helps to reduce out-of-balance post weld shift forces that tend to induce additional misalignment between the ferrule 104 and the laser chip 114. Also, the laser welding between the ferrule 104 and the clip 106 can be performed by applying the beams 156 and 158 between the ferrule 104 and the clip 106, for example, at welds 120 and 122 of FIG. 3.

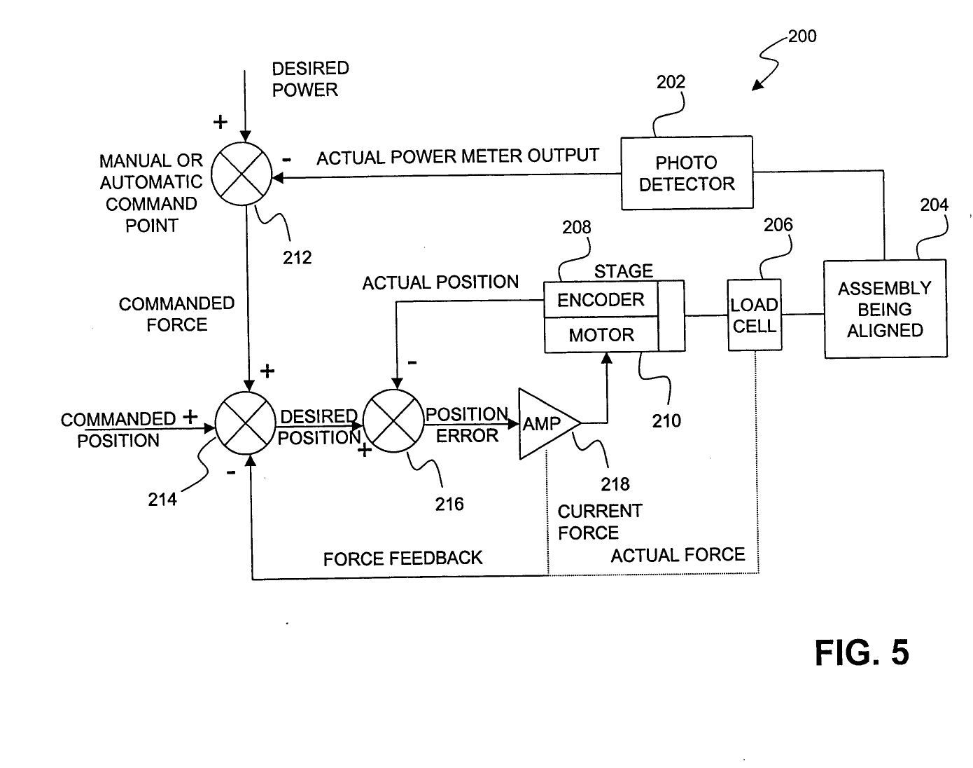

FIG. 5 illustrates a control loop 200 (“control feedback loop 200”), which may be used for positioning and for performing force bend alignment between the optical fiber (in the ferrule) and the laser chip in an exemplary embodiment according to the present invention. In the control loop 200, an output of the assembly being aligned 204 is detected by a photodetector 202, which provides a signal indicative of an actual power meter output (“actual power signal”). The actual power meter output may be used to determine whether sufficient signal strength is being detected after laser welding and/or to determine the direction of the peak signal relative to the current position during the force bend alignment.

The actual power signal may also be provided to a subtractor 212, which may also receive a signal indicative of desired power output (“desired power signal”). The desired power signal, for example, may be provided and/or known by a user based on test data for the desired power output. The desired power signal may=have been derived using the actual power meter signal as read by an operator and/or fed into the system controlling software program. The desired power signal may be used either manually of automatically to determine the magnitude of force that needs to be applied.

The subtractor 212 may subtract the actual power signal from the desired power signal to generate a power differential that can be used to determine the magnitude of the commanded force to be applied to the assembly being aligned. This determination of the commanded force may be generated manually and/or automatically.

The commanded force may be applied to a subtractor 214, which may also receive a commanded position signal and/or a force feedback signal. The commanded position signal may be indicative of the nominal position of the stage, and the stage may tend to stay at the commanded position in the absence of the commanded force and the force feedback signal. The force feedback signal may be provided as the measure of current (“current force signal”) used to drive the motor 210 of the stage or as a measure of an actual force detected by a load cell 206. The motor 210 may include a number of motors, each per stage (e.g., y, θx, θy, θz stages). The control loop 200 may typically try to balance the commanded force with the force feedback signal when both of them are used.

The desired position signal generated by the subtractor 214, therefore, may be viewed as a difference between the commanded force and the force feedback signal about the commanded position (i.e., nominal position). The desired position signal to achieve a commanded force and/or force profile may be automatically provided by the subtractor 214 based on feedback from a direct force reading via a load cell and/or a holding current on one or more of the stage motors.

The current force signal is provided by an amplifier 218, the magnitude of which may have been automatically determined by the comparison at the subtractor 214 of the actual force (i.e., force feedback) versus demanded force (i.e., commanded force), which is used to drive the motor 210. The amplifier 218 may be driven by a position error signal from a subtractor 216, which may be a difference between the desired position signal and an actual position signal provided by an encoder 208 of the stage.

The actual force signal measurement being applied, for example, by a gripper, required for feedback into the subtractor 214 can be supplied via and through the direct measured force from the load cell 206 and/or the pre-calibrated holding current on the stage motor. These force signal levels may always be available for the operator to view, though they may only be used by the machine during force bend alignment. Because of the availability and use of the force feedback signals (either the direct measured force or the pre-calibrated holding current), the applied force vector can be accurately communicated to the part even in the presence of imperfections in the tooling and/or other mechanisms.

The load cell 206 includes a force transducer for directly measuring the force applied to the assembly being aligned 204. Since the assembly being aligned 204 is more sensitive to the force in the y-direction than in the x-direction, the load cell 206 should be used to measure at least the actual force applied in the y-direction. On the other hand, the assembly being aligned 204 is less sensitive to the force in the x-direction, and the load current may be used to measure the force applied in the x-direction. Since the amount of torque or force of the motor is linear with respect to the load current applied to it, the load current is a good indication of the force being applied to the assembly being aligned 204 in the x-direction. Of course, another load cell may be used to measure force directly in the x-direction as well.

Since the control feedback loop 200 of FIG. 5 has both force and position feedback loops, a force feedback loop (through actual or current force feedback) and an actual position feedback loop (through the action position signal generated by the encoder), it can be force and/or position driven. For example, during the initial alignment of the optical components (e.g., between the ferrule and the laser), the control feedback loop 200 may be position driven, through which the relative positions of the optical components can be adjusted. Further, during force bend alignment (i.e., in the force bend mode), the control feedback loop 200 may be force driven to bend one or more parts for post weld shift correction.

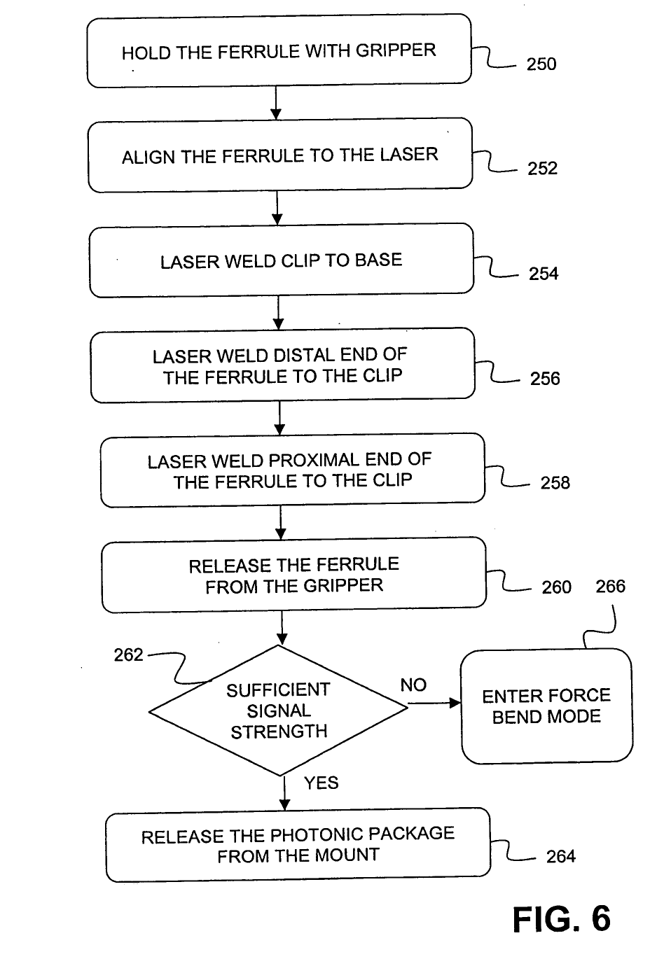

FIG. 6 is a flow diagram illustrating a process of aligning opto-electronic components of a photonic package in an exemplary embodiment of the present invention. This flow diagram may perhaps be best described in reference to FIGS. 3 and 7. FIG. 7, for example, illustrates a gripper 270 gripping the ferrule 104, which is laser welded to the clip 106, which in turn has been laser welded to the package 102.

In step 250, the ferrule 104 is held with the gripper 270, and in step 252, the ferrule 104 is aligned to the laser. For example, the control feedback loop into the motors of FIG. 5 may be position driven through encoder feedback (“actual position signal”) during the alignment of step 252. In step 254, the clip 106 is welded to the base 103 with welds 116 and 118. The welds 116 are at a distal end (end far from the laser) of the ferrule 104, while the welds 118 are at a proximal end (end close to the laser) of the ferrule 104. In the exemplary embodiment, the welds 116 at the distal end are performed, and then welds 118 at the proximal end. This sequence may be reversed in other embodiments.

In step 256, the distal end of the ferrule 104 is welded to the clip at the welds 120. Then in step 258, the proximal end of the ferrule 104 is welded to the clip 106 at the welds 122. At the end of this welding, the ferrule 104 is released from the gripper in step 260.

In step 262, the output of the photodetector is tested for sufficient signal strength, which may be predetermined (e.g., defined by customers' specification and/or other criteria). For example, the sufficient signal strength may be determined when the signal strength of 80-90% of that found during the initial alignment process is realized. If the sufficient signal strength has been realized, then the assembly process ends, and the assembled photonic package is removed from the mount/stage as indicated in step 264.

However, due to such undesirable phenomena as post-weld shift, material phase changes and/or material shrinkage, etc., the signal often does not have sufficient strength. In that case, the fiber and the laser should be re-aligned by permanently (e.g., plastically) deforming the clip and ferrule assembly relative to the laser diode. In other words, a force bend mode should be entered as indicated in step 266 to re-align the optical fiber in the ferrule to the laser.

In the force bend mode in an exemplary embodiment according to the present invention, the ferrule 104 is re-gripped by the gripper 270 and then moved (e.g., in multi-dimensional directions by moving the gripper 270 and/or the stage in x-y plane) such that relative motion occurs between the gripper and the photonic package, thereby bending (plastically mechanically deforming) the clip. To realize the relative motion, the stage and/or the gripper may be moved.

Referring back to FIG. 5, in the force bend mode the feedback loop into the motors may be changed from being position driven through encoder feedback (“actual position signal”) to force driven using, for example, actual force measurement (“actual force signal”) through a load cell in the y axis and/or the holding position voltage (“current force signal”) in the x axis.

In the exemplary embodiment, load cell 206 is used in the y axis as the y stage is not frictionless, whereas the holding voltage can be used to derive the force in the x axis as this is a linear motor stage with near zero friction. If the motor is not frictionless, the holding current typically cannot be accurately calibrated to a force, as the static friction may not be consistent and therefore may create error that may be too large for optical alignment purposes.

Further, the sensitivity of the fiber alignment typically is not symmetrical and may be more sensitive to misalignment in the y axis than the x axis. Therefore, the direct feedback from a load cell is more desirable in the y axis. Even with linear motors in the y axis, it is likely that the friction would still be too high for bend alignment purposes.

FIG. 7 is a perspective view of a gripper (“grippers”) 270 being used for alignment of optical components in an exemplary embodiment according to the present invention. In order to scan the ferrule in relation to the optical source (e.g., laser diode) or receiver (e.g., photodetector), a certain amount of clamping force should be exerted to overcome the drag of the fiber-to-ferrule connection, and possibly the friction of the clip against the welding base. The clip may be loaded at any time before, during or after the alignment stage. When loading the clip after the alignment stage, the clamping force is important as the action of sliding the clip, even though it is a slip fit, over the ferrule may tend to induce misalignment. Hence, during the initial alignment, the gripper 270 should firmly grip the ferrule 104.

During the weld attachment, and especially during front and rear (proximal and distal) welds of the ferrule 104 to the clip 106, the gripper 270 may be used as a contact tool that enables the stages to re-peak the detected signal and introduce further weld offsets to counteract the post weld shift (PWS) induced by the final weld of the distal end of the ferrule 104 to the clip 106.

On completing the final attachment weld with the gripper 270 still clamped to the ferrule 104, in most instances an orthogonal force and/or a torsion force is actin on the gripper 270, as a result of PWS, the re-peaking stage and/or the introduction of weld offsets. This may be observed, for example, when the gripper 270 is released and the coupled signal is reduced below acceptable levels. The original no force, no torsion clamping plane of the gripper 270 on the ferrule 104 may no longer exist.

If the gripper 270 is once again re-clamped (thereby grabbing the ferrule), the signal may change in accordance with this post weld out of plane gripping force or torsion. This may also be experienced in a similar way when the assembly is plastically deformed to bend the fiber tip back into alignment. Plastically deforming the clip 106 repositions the zero force clamping point again, and it is highly likely that this still does not correspond to the gripper surface. Therefore, once the assembly has been deformed into alignment, there should be zero orthogonal force. However due to torsion, the release of the gripper 270 may nominally cause a loss of signal. This may be significant depending on the amount of torsion exerted by the gripper 270.

During the force bend alignment, the gripper 270 may exert orthogonal forces that are measured with the direct load cell and/or motor holding current. In other embodiments, torsion forces that exist in θx, θy, θz may also be measured for more precise application of the force vectors. In the exemplary embodiment, a soft or loose gripper that does not support (or exert) torsion forces is used in the force bend mode so that the measurement of these torsion forces may not be needed.

The use of a “soft” gripper effectively grips the ferrule loosely during the bend alignment process. The looseness of the gripper does not support torsion forces. Therefore, the release loss may be vastly reduced and within acceptable levels. In an exemplary embodiment, to make the change from “hard” to “soft”, a pneumatic gripper stop 272 may be moved between the gripping members of the gripper, such that when the gripper is commanded to close, the stop prevents complete closure. The gripper stop may include two adjustment screws 274 located on the two sides of the gripper stop, and may be altered to adjust the looseness of the grippers.

In practice, the force bend mode is initiated before the gripper 270 re-grabs the ferrule 104; this initialization zero's the force values on x and y. The gripper 270 is then closed around the ferrule 104. It is likely that the closing of the gripper 270 onto the ferrule 104 induces a force in either or both the x and y axes. Through the force feedback loop of the load cell value (“actual force signal”) and holding voltage (“current force signal”) on the x stage, the motors in the x and y axes act to correct this such that the forces are once again returned to zero. In other embodiments, additional force detection mechanisms may be used.

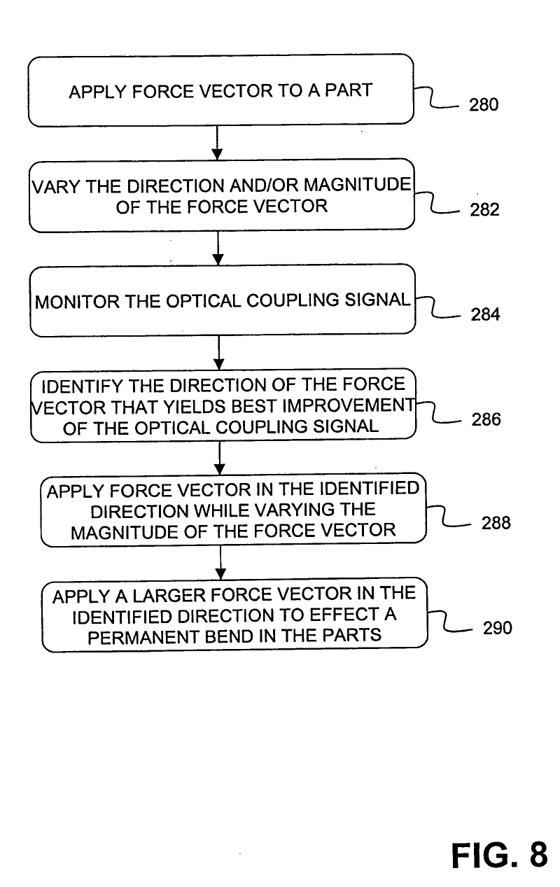

FIG. 8 is a flow diagram illustrating a process of force bend alignment in an exemplary embodiment according to the present invention. During the exemplary force bend alignment process, the control feedback loop of 200 should be force driven to exert a desirable level of control over the applied force vector. In step 280, a force vector is applied to one or more of the parts. Then as indicated in step 282, the direction and/or the magnitude of the force vector is varied. Concurrently to applying the varying force vector, the optical coupling signal is monitored in step 284 to identify in step 286 the direction of the force vector that yields the best improvement of the optical coupling signal. The direction identified in step 284 may, for example, be referred to as an “optimum force direction (OFD).”

Then in step 288, a varying force vector is applied in the direction identified in step 286 (i.e., OFD). By way of example, the magnitude of the force vector may be steadily increased from zero force to a predetermined maximum force and back to zero force while observing the optical coupling signal. If the direction identified in step 286 is the correct direction, a larger force vector is applied in that direction (i.e., OFD) to effect a permanent (plastic) bend in the parts.

It should be noted, however, that the actual direction in space that the parts bend may not be the same as the direction in which the force is applied. It should also be noted that the same force magnitude applied in different directions may produce different amounts of bending of the parts in space. These differences may result, for example, from an anisotropic nature of the part due to its geometry, materials, and/or the existence of previous welds.

Mathematically, the bending position vector is a product of the stress tensor and the force vector. Hence, the direction of the bending position vector is not necessarily the same as the direction of the applied force vector. In fact, the only time the directions would be the same is when the applied force vector is in the direction of one of the eigenvectors of the stress tensor matrix.

Further, the stress tensor typically changes whenever the part experiences plastic deformation. This means that even if a user figures out what direction the parts move when the force is beginning to be applied, the relationship between bend position change direction and applied force direction may change as the user increases the force beyond the point where plastic deformation occurs. Therefore, the final bend alignment typically cannot be made in one step. Hence, in practical applications, the bend alignment procedure is performed iteratively, commanding the system to make a series of small incremental improvements. The method of bend alignment can be tailored to each optical attachment, in that the precise nature of the part and optical sensitivity in each axis will naturally imply a preferred method. One stated method involves bending the assembly directly along the angle of peak signal, however an alternatively is too achieve bend alignment through bending in the orthogonal axis directions only. During this process the signal may actually be bent to a temporary low point in order to finally peak through bending in another axis.

By way of example, every time a weld is added to the part or the part is deformed beyond its elastic limit somewhere, the stress tensor changes and steps 280, 282, 284 and 286 of FIG. 8 should be performed again to find the best direction to apply the plastic bending force.

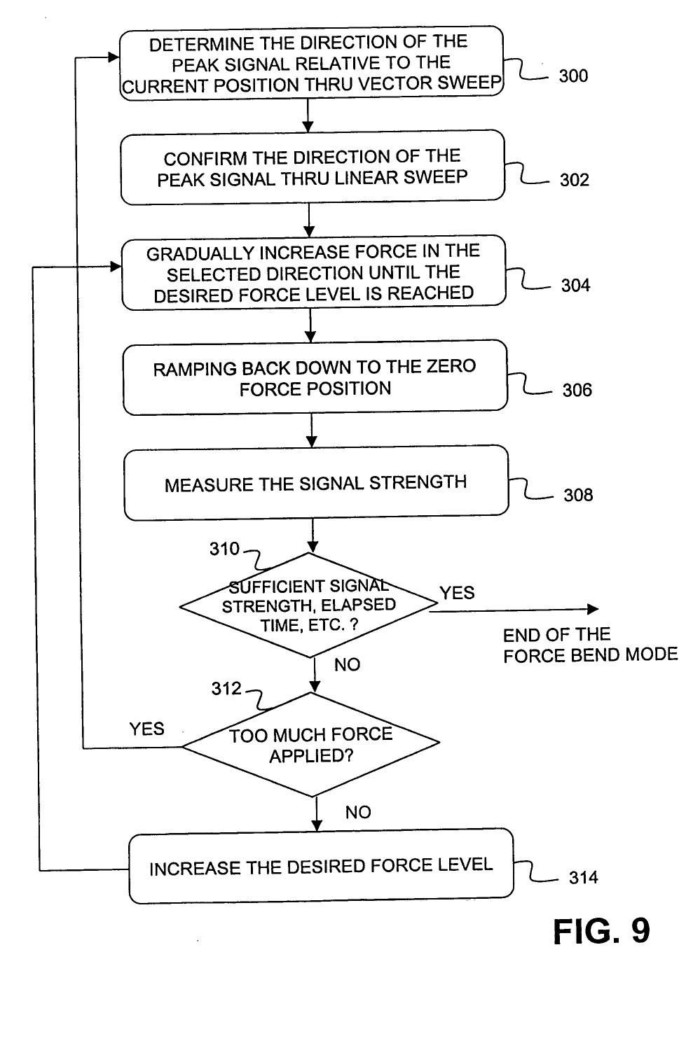

FIG. 9 is a flow diagram illustrating an iterative process of force bend alignment using a linear force mode in an exemplary embodiment according to the present invention. The control loop 200 of FIG. 5 should be force driven using the force feedback signal in this embodiment as well.

When the linear force mode bending is being performed, a number of observations are used to determine the progress of the bending process. In order to plastically deform the assembly, the fiber tip is pushed past the peak then allowed to relax in a controlled manner. When the linear force mode is initiated, the maximum peak signal observed each time indicates whether or not the peak angle direction is changing under the action of bending. Also, the level of signal reached at peak force point particularly the repeated sweeps at the same force level indicates the level deformation occurring. A good identifier is the change in the zero force signal.

The absolute forces used in the force bend alignment are related to the stiffness of the clip and ferrule assembly, which is a function of the clip design, number and location of welds on the clip, the length of the ferrule, the position the grippers on the ferrule, etc. A typical bend align may start at 2 N, with force level increases of 1 N steps in the y axis, and 2 N steps in the x axis, due to stiffness difference. In the y axis deformation should normally occur by 5 N, thereafter depending upon the level of signal change versus applied force the force level is increased by 0.5 N steps. In the x axis this deformation force level can be 8 N+, thereafter 2 N increases are usually used. The alignment sensitivity of the signal is more sensitive approaching the peak, with a small plateau at the peak. Ideally, the bending should position the fiber in the center of the plateau.

In step 300, the direction of the peak signal relative to the current position is determined through a multi-dimensional (e.g., circle or ellipse) sweep. First, a small (elastically deforming) force vector is applied to one of the optical parts, holding the other reasonably still in the fixturing. The force value used is typically 1 to 2 Newton (N), and should be constant or substantially constant in magnitude during the sweep. The force value used may be different in other embodiments.

For example, the gripper 270 may grab the ferrule 104 and initially move directly upward until the required force value is reached. Then the direction of the force vector may be changed in a smooth pattern (circle or other pattern in two or more dimensions) at a controlled rate. For example, the gripper may sweep through 360 degrees (e.g., in one degree increments) at the inputted force. The sweep should not result in a plastic deformation of the clip 106 or any other component.

After the sweep has been completed, the gripper 270 returns to the zero force position. Even when a force vector of equal magnitude is exerted in every direction (e.g., 360 degree circle sweep), the stiffness of the clip/ferrule assembly is higher in the x axis compared to the y axis, such that the shape that is truly described may be that of an ellipse. During the sweep, relative increase and decrease in optical signal as a function of force vector should be measured and recorded. Further, the direction and force and relative change in optical signal at the point of largest signal increase should be noted. For example, as the sweep progresses, the maximum peak angle should be returned to a display, and should remain at the highest value found. It should be noted that lost motion and elastic flexing in the stages and tooling may have little or no effect on this process because the applied force vector is controlled using the force feedback signal.

Then in step 302, the direction of the peak signal should be confirmed through a linear sweep. During the linear sweep, the force may be swept from 0 to some force value that does not plastically deform the clip. The linear sweep confirms the direction of peak signal and provides information of at what level of force the highest signal occurred along the sweep. The other recorded parameters may be used to estimate the magnitude of the required force. Also, the force may be swept so as to cause the optical signal to at first increase, then start to decrease (indicating excess force) as an element in an overall automated post-attachment alignment technique. A signal rise may confirm that the direction is correct. If no signal rise is observed, then the force sweep (e.g., circular sweep) may be repeated, for example, with a 2 N force.

With the direction of peak signal confirmed the clip and ferrule assembly should be bent towards that peak. The bending may be achieved by two methods; the repeated application of an impulse force (e.g., linear force mode or linear sweep mode) or the repeated application of a constant force (e.g., constant force mode).

The linear force mode, for example, may be applied as illustrated on FIG. 9. In this mode, a force value is entered along with an angle, the gripper 270 is then moved along this angle line such that the inputted force is gradually approached as in step 304. Once the force level is reached, the gripper 270 is then moved back along the line ramping back down to the zero force position as in step 306.

Increasing levels of force may be applied along the peak angle line to induce plastic deformation on the assembly. After each linear sweep the system is returned to a zero force position, and an increase in signal strength measured in step 308 at the zero position may indicate whether permanent bending has occurred. If no change has occurred or a very small change has occurred, then the force level may be increased in step 314, and if too much force has been applied as determined in step 312, then a force sweep in step 300 may be repeated to reinitiate the bending process. This iterative process may continue until the predefined (i.e., predetermined) sufficient signal strength (e.g., 80-90% of the signal detected during the initial alignment) has been achieved as in step 310, and the force bend mode terminates. In other embodiments, the force bend mode may terminate upon occurrence of a predetermined event, such as, for example, elapse of a predetermined time.

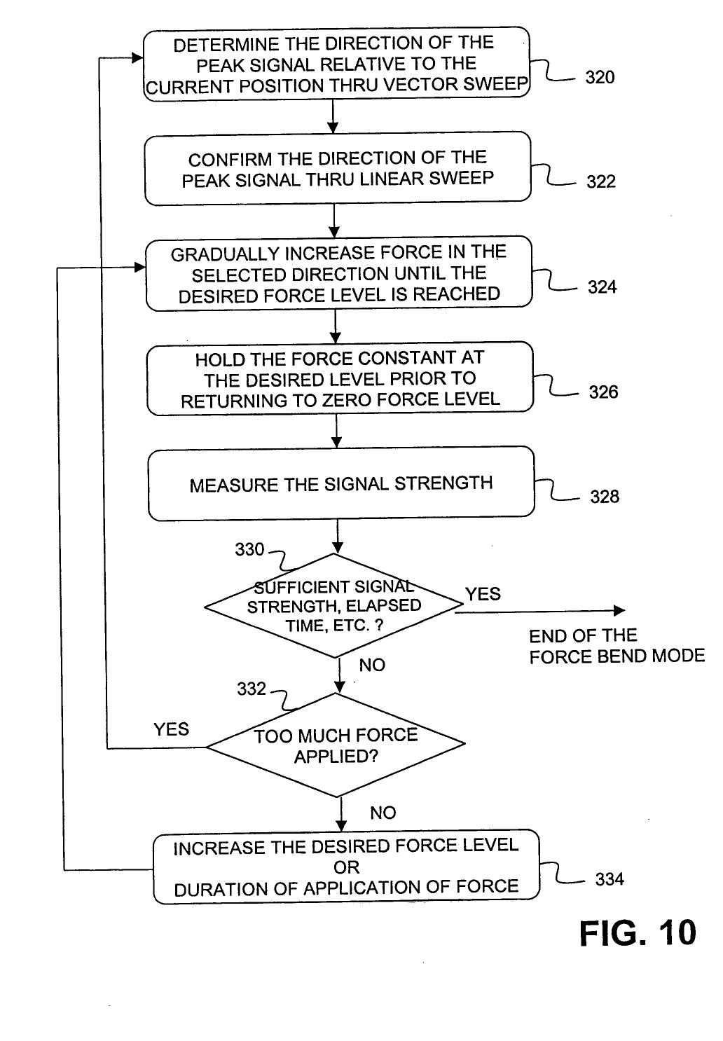

The use of the constant force mode, for example, is illustrated in FIG. 10. The use of the constant force mode is similar to the use of the linear force mode. In fact, the steps 320, 322, 324, 328, 330 and 332 may substantially be the same as the steps 300, 302, 304, 308, 310 and 312, respectively, of FIG. 8. In the constant force mode, the force is applied as for the linear mode, however, instead of returning to zero the force level is held constant until canceled, then the gripper 270 returns to zero force position. The return to zero force position may be rapid or gradual. This method should typically be applied in a near orthogonal x direction, as the y axis may be too sensitive for this method.

The time that the force is held at a constant level is related to the change in the signal level while the force is applied. Similarly to the linear force mode the constant force is ramped up from a starting value in step 324, usually being held for about 5 seconds as in step 326. The zero return signal measured in step 328 indicates the level of bending, and the need to increase the force or the time held at that force in step 334. The return to zero is a good static indicator, however the level of the signal reached at constant force level and the creep of the signal under the force are dynamic indicators as to whether and to what extent bending is occurring. In step 334, the desired force level may be increased and/or the duration of the application of force may be lengthened.

Although this invention has been described in certain specific exemplary embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive.

For example, the embodiments of the present invention have been described in reference to an optical transmitter where an optical fiber is aligned with a laser chip. The principles of the present invention, however, are equally applicable to a receiver where the optical fiber is aligned with a photodetector or the like.

1. A method of aligning optical components of a photonic package, said method comprising:
initially aligning the optical components;
fixing the optical components with respect to one another through laser welding;
determining a direction to deform at least one of the optical components through performing a sweep of force vectors; and
applying a force in the determined direction to plastically deform said at least one of the optical components to re-align the optical components.

2. The method of claim 1, wherein initially aligning comprises: providing an actual position signal as a feedback; and driving at least one motor to align the optical components using the actual position signal.

3. The method of claim 1, wherein applying the force in the determined direction comprises: providing a force feedback signal; and controlling an applied force vector using the force feedback signal.

4. The method of claim 1, further comprising performing a linear sweep of force vectors to confirm the determined direction.

5. The method of claim 1, wherein performing the sweep of force vectors comprises elastically deforming at least one of the optical components using the force vectors.

6. The method of claim 5, wherein performing the sweep of force vectors further comprises measuring an optical signal output associated with each force vector.

7. The method of claim 6, wherein determining the direction comprises selecting the direction of a largest optical signal output measured during the sweep.

8. The method of claim 1, wherein applying the force comprises: grabbing one of the components; and moving the grabbed one of the components in the determined direction.

9. The method of claim 1, wherein applying the force comprises gradually increasing the force in the determined direction until a desired force level has been reached.

10. The method of claim 9, wherein applying the force further comprises gradually decreasing force to a zero force level.

11. The method of claim 10, further comprising measuring an optical signal output after the force has been decreased to the zero force level.

12. The method of claim 11, wherein applying the force further comprises holding the force constant at the desired force level for a predetermined period of time prior to gradually decreasing the force.

13. The method of claim 12, wherein a duration of the constant force is increased if the optical signal output does not have a predetermined strength.

14. The method of claim 13, further comprising applying the force to plastically deform said at least one of the optical components after increasing the duration of the constant force.

15. The method of claim 11, wherein the desired force level is increased if the optical signal output does not have a predetermined strength.

16. The method of claim 15, further comprising applying the force to plastically deform said at least one of the optical components after increasing the desired force level.

17. The method of claim 1, further comprising, if too much force has been applied, determining the direction to deform said at least one of the optical components through performing the sweep of force vectors; and applying the force to plastically deform said at least one of the optical components.

18. The method of claim 1, further comprising, if the direction cannot be determined, increasing a magnitude of the force vectors; and performing the sweep of force vectors.

19. The method of claim 1, wherein performing the sweep of force vectors comprises performing the sweep of force vectors on an X-Y plane.

20. A system for performing a force bend alignment to re-align optical components of a photonic package after permanent fixation, comprising:
a stage capable of providing movements and exerting force in at least one direction; and
a gripper suitable for grabbing an optical component of the photonic package,
wherein the gripper performs a sweep of force vectors on at least one of the optical components of the photonic package in an automated manner to determine a direction to deform a supporting member coupled to said at least one of the optical components to re-align the optical components.

21. The system of claim 20, wherein a force vector is applied to the supporting member to deform it, said system further comprising a control feedback loop for providing a force feedback signal and for adjusting the applied force vector using the force feedback signal.

22. The system of claim 21, wherein the force feedback signal is used to zero out forces exerted by the gripper upon grabbing the optical component to perform the sweep of force vectors.

23. The system of claim 21, wherein the control feedback loop provides an actual position signal, which is used to control initial alignment of the optical components.

24. The system of claim 20, wherein said at least one of the optical components is plastically deformed so as to realize the re-alignment.

25. The system of claim 24, wherein the optical components comprise a ferrule, and the supporting member comprises a clip attached to the ferrule, and wherein the clip is plastically deformed by grabbing the ferrule with a gripper and exerting force on it through moving at least one of the stage and the gripper.

26. The system of claim 25, wherein the optical components further comprise a laser or photodetector, and wherein the re-alignment is between the ferrule and said laser or photodetector.

27. The system of claim 25, wherein a direction to deform the clip is determined through measuring an optical signal after applying each force vector during the sweep.

28. The system of claim 27, wherein a linear sweep of the force vectors is performed to confirm the direction to deform.

29. The system of claim 25, wherein the gripper grabs the clip softly or loosely, whereby the gripper does not exert torsion forces.

30. A method of aligning optical components of a photonic package, said method comprising:
a) aligning the optical components;
b) fixing the optical components with respect to one another through laser welding;
c) determining a direction to deform one of said optical components through performing a sweep of force vectors;
d) applying a force to plastically deform said one of the optical components to re-align the optical components;
e) measuring an optical signal after said plastic deformation;
f) performing c) through e) if too much force has been applied; and
g) increasing force level and performing d) through e) if too little force has been applied.

31. The method of claim 30, wherein applying a force in step d) comprises: providing a force feedback signal; and controlling the applied force using the force feedback signal.

32. The method of claim 30, wherein performing the sweep of force vectors in step c) comprises performing the sweep of force vectors on at least an X-Y plane.
